(19) United States
(12) Patent Application Publication
(10) Pub. No.: US 2019/0036770 A1
(43) Pub. Date: Jan. 31, 2019

(54) NETWORK ROUTE PROVISIONING

(71) Applicant: Cisco Technology, Inc., San Jose, CA (US)

(72) Inventors: Nehal BHAU, San Jose, CA (US); Linus Ryan ARANHA, Los Gatos, CA (US); Murtuza ATTARWALA, Davis, CA (US)

(21) Appl. No.: 16/019,782

(22) Filed: Jun. 27, 2018

Related U.S. Application Data
(60) Provisional application No. 62/539,423, filed on Jul. 31, 2017.

(51) Int. Cl. H04L 12/24; H04L 12/721; H04L 12/707; H04L 12/723; H04L 12/851; H04L 12/26; H04L 12/46

(52) U.S. Cl. CPC H04L 41/0806; H04L 41/5025; H04L 45/38; H04L 12/4633; H04L 45/50; H04L 47/24; H04L 43/16; H04L 45/24

(57) ABSTRACT

A system may include a first network device with a first circuit to communicate over a first modality and a second circuit to communicate over a second modality, and a second network device with a third circuit to communicate over the first modality and a fourth circuit to communicate over the second modality. The second network device may perform operations that include receive a data flow directed to the first network device, obtain a circuit preference for the second network device, based on the circuit preference, provision a first tunnel using the third circuit to the first network device as a primary tunnel and provision a second tunnel using the fourth circuit to the first network device as a secondary tunnel. The operations may also include, detect an interruption in the data flow of the primary tunnel, and transmit a second packet in the data flow over the secondary tunnel.

### CROSS REFERENCE TO RELATED APPLICATIONS

This application claims priority to U.S. Patent App. No. 62/539,423, filed Jul. 31, 2017, which is hereby incorporated by reference in its entirety.

### FIELD

The embodiments discussed in the present disclosure are related to network route provisioning.

### BACKGROUND

The use of networks is a useful tool in allowing communication between distinct computing devices. Despite the proliferation of computers and networks over which computers communicate, there still remain various limitations to current network technologies.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One or more embodiments of the present disclosure may include a method of network route provisioning. The method may include receiving, at a second network device, a data flow directed to a first network device, where the first network device includes a first circuit to communicate over a first modality and a second circuit to communicate over a second modality, and where the second network device includes a third circuit to communicate over the first modality and a fourth circuit to communicate over the second modality. The method may also include, in response to receiving the data flow, obtaining a circuit preference including second network device circuit preference between the third circuit and the fourth circuit. The method may additionally include, based on the circuit preference, provisioning a first tunnel from the third circuit over the first modality to the first network device as a primary tunnel, and provisioning a second tunnel from the fourth circuit over the second modality to the first network device as a secondary tunnel. The method may also include transmitting a first packet in the data flow over the primary tunnel, detecting an interruption in the data flow of the primary tunnel after provisioning the second tunnel, and, in response to the detection of the interruption, transmitting a second packet in the data flow over the secondary tunnel.

One or more embodiments of the present disclosure may additionally include non-transitory computer readable media for facilitating the performance of such methods.

One or more embodiments of the present disclosure may include a system that may include a first network device with a first circuit configured to communicate over a first modality and a second circuit configured to communicate over a second modality, and a second network device with a third circuit configured to communicate over the first modality and a fourth circuit configured to communicate over the second modality. The second network device may be configured to perform operations that include receive a data flow directed to the first network device, and, in response to receiving the data flow, obtain a circuit preference including second network device circuit preference of the second network device between the third circuit and the fourth circuit. The operations may also include, based on the circuit preference, provision a first tunnel from the third circuit over the first modality to the first network device as a primary tunnel, and, based on the circuit preference, provision a second tunnel from the fourth circuit over the second modality to the first network device as a secondary tunnel. The operations may also include transmit a first packet in the data flow over the primary tunnel, detect an interruption in the data flow of the primary tunnel after provisioning the second tunnel, and in response to the detection of the interruption, transmit a second packet in the data flow over the secondary tunnel.

The object and advantages of the embodiments will be realized and achieved at least by the elements, features, and combinations particularly pointed out in the claims.

It is to be understood that both the foregoing general description and the following detailed description are merely examples and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example system of network components implementing a software-defined network;

FIG. 2 illustrates another example system of network components implementing a software-defined network;

FIG. 3 illustrates an example table of tunnel priorities;

FIGS. 4A and 4B illustrate a flowchart of an example method of network route provisioning; and

FIG. 5 illustrates an example computing system.

### DESCRIPTION OF EMBODIMENTS

Some embodiments of the present disclosure relate, inter alia, to improvements to the operation of networks, and provisioning network tunnels. In a network that includes multiple tunnels for routing network traffic between two nodes in the network, having a primary tunnel and a secondary tunnel allows for a rapid transition between tunnels and maintaining data continuity if or when the primary tunnel experiences a failure or degradation. The use of a software-defined network allows for greater flexibility in provisioning primary and secondary tunnels between such nodes. In some embodiments, a local device may transmit network traffic over a primary tunnel based on preferences of the local device and/or the remote device relative to a circuit utilized in the primary tunnel. For example, the local device may be a network device with a circuit for communicating over Long Term Evolution (LTE) and a circuit for communicating over broadband Internet. Transmitting network traffic over LTE may be more expensive than transmitting network traffic over broadband Internet, and thus, the broadband Internet circuit may be a preferred circuit for the local device. The remote device may be a network device that equally prefers to receive data over broadband Internet. Based on those preferences, a tunnel over the broadband Internet circuits may be designated as a primary tunnel and a tunnel utilizing LTE may be designated as a secondary tunnel. In these and other embodiments, the secondary tunnel may be provisioned at the same time as the primary tunnel.

In these and other embodiments, if the local device detects an interruption in the data flow along the primary tunnel, the local device may automatically start sending packets of network traffic along the secondary tunnel. In these and other embodiments, the designated secondary tunnel may be so designated based on the circuit preferences.

One or more embodiments of the present disclosure may solve a computer-centric problem and may cause a corresponding computer and/or computer network to operate in an improved manner. For example, using one or more embodiments of the present disclosure, a network may be more reliable and have fewer dropped packets when there is an interruption in data flow along a tunnel through the network. Such a benefit in turn causes the computers relying on the data flow (including, for example, an application operating on a computer that utilizes the data flow) to operate in an improved manner. As an additional example, the network may operate more efficiently as primary and secondary tunnels may be designated based on preferences of the various devices and the most preferred tunnels may be used, even in a backup situation. Furthermore, redundancy within networks gain greater flexibility and customizability because the redundancy is based on circuit preference at one or both ends, rather than simply switching to a standby circuit.

Embodiments of the present disclosure are explained with reference to the accompanying drawings.

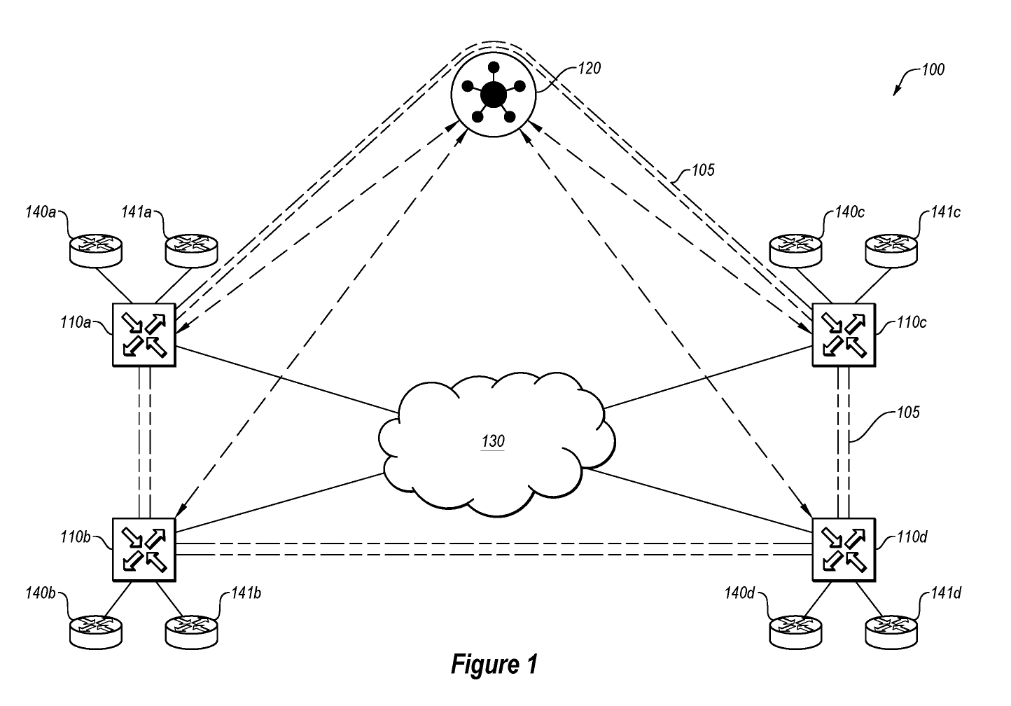

FIG. 1 illustrates an example system 100 of network components implementing a software-defined network, in accordance with one or more embodiments of the present disclosure. The system 100 may include an internal network domain 105 and one or more external network domains. The system 100 may include one or more edge network devices 110 (such as the edge network devices 110a-110d), a control device 120, and a communication network 130.

The system 100 may implement a software-defined network. A software-defined network may include a network that is managed by software rather than controlled by hardware. As such, a software-defined network may support multiple types of connections, such as the Internet, multi-protocol label switching (MPLS) connections, and/or cellular connections (such as LTE, LTE Advanced, Worldwide Interoperability for Microwave Access (WiMAX), Evolved High Speed Packet Access (HSPA+), and/or others). Additionally, a software-defined network may support load balancing or load sharing between the various connections. Further, because of the distributed nature of a network, a software defined network may support virtual private networks (VPNs), firewalls, and other security services. In a software-defined network, for example, a control plane may be functionally separated from the physical topology. In some embodiments, a software-defined network may separate the control plane of the network (to be managed via software) from a data plane of the network (operating on the hardware of the network). As used herein, the term control plane may refer to communications and connections used in the control and administration of a network itself, rather than the transmission of data through the network, which may occur at the data plane. As used herein, the term data plane may refer to communications and connections used in the transmission and reception of data through the network. For example, the control plane may include administrative traffic directed to a network device within a network, while the data plane may include traffic that passes through network devices within the network.

In some embodiments, a software-defined network may be implemented as a software-defined wide area network (SD-WAN), local area network (LAN), metropolitan area network (MAN), among others. While one or more embodiments of the present disclosure may be described in the context of an SD-WAN, such embodiments may also be implemented in any software-defined network.

In some embodiments, the control device 120 may be configured to manage the control plane of an internal network domain 105 by directing one or more aspects of the operation of the edge network devices 110. For example, the control device 120 may generate and/or distribute circuit preferences to one or more of the edge network devices 110. The circuit preferences may indicate a preference order for transmitting and/or receiving data over the data plane. The internal network domain 105 may operate as a secured and controlled domain with specific functionality and/or protocols. In some embodiments, the edge network devices 110 may operate based on one or more policies created and/or propagated by the control device 120.

In some embodiments, the edge network devices 110 may not have stored the topology and/or route paths of the entire system 100. Each of the edge network devices 110 may not need to query each other individually to determine reachability. Instead, the control device 120 may provide such information to the edge network devices 110. In these and other embodiments, the control device 120 may be configured to manage the data plane of the system 100 by directing one or more aspects of the operation of the edge network devices 110.

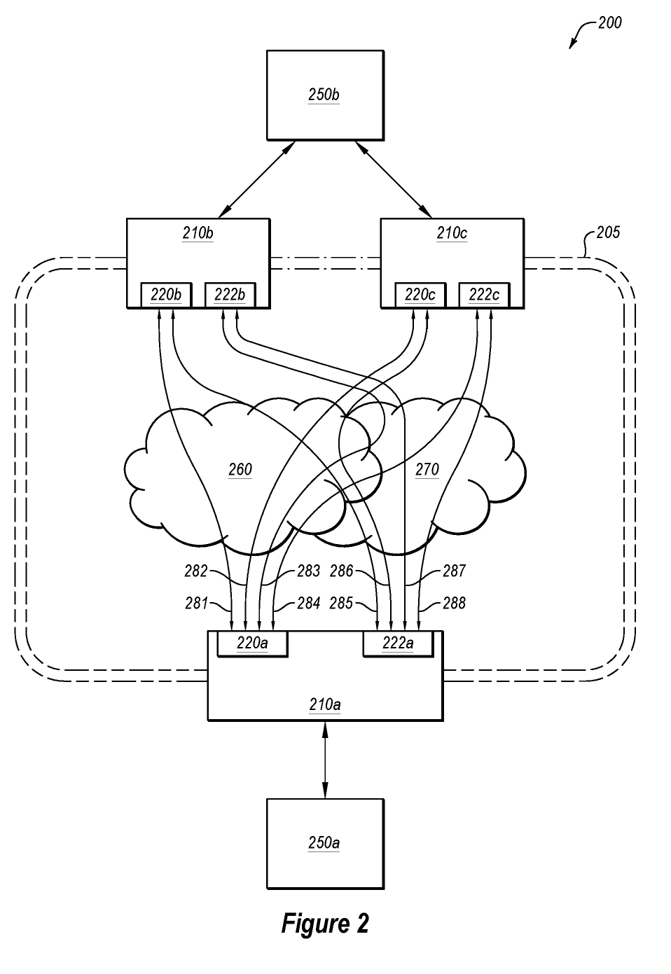

In some embodiments, a given edge network device 110 may provision a first tunnel to another edge network device based on the preferences of the given edge network device 110 and/or the preferences of the edge network device with which the given edge network device 110 is communicating. Such a tunnel may be the primary tunnel for communication through the internal network domain 105 between the given edge network device 110 and the other edge network device. Additionally or alternatively, when provisioning the primary tunnel, one or more additional tunnels may be also provisioned as backup or secondary tunnels. By provisioning the secondary tunnels at the time of provisioning the primary tunnel, drops or losses in network connectivity may be avoided and rapid transitions to secondary tunnels may be accomplished. The given edge network device 110 provisioning the tunnels for communicating in the internal network domain 105 is discussed in further detail below in conjunction with FIG. 2.

The edge network devices 110 may operate at a boundary of the internal network domain 105. The edge network devices 110 may include one or more physical and/or logical connections that may operate within the internal network domain 105. Such connections may be illustrated as part of the communication network 130. Additionally or alternatively, the edge network devices 110 may include one or more physical and/or logical connections operating outside of the internal network domain 105. In some embodiments, the edge network devices 110 may determine a preferred order (e.g., a circuit preference) for the one or more physical and/or logical connections between each of the edge network devices 110. In some embodiments, the edge network devices 110 may determine a priority of tunnels for transmitting data between each of the edge network devices 110 by combining the circuit preferences associated with each of the edge network devices 110. The edge network devices 110 determining circuit preferences and tunnel priorities is discussed in further detail below in conjunction with FIG. 2.

In some embodiments, each circuit for an edge network device 110 may be independently identifiable. For example, an edge network device 110 with a port coupled to an LTE connection, a port coupled to an MPLS connection, and a port coupled to a broadband Internet connection may include three identifiers of circuits, one for the LTE connection, one for the MPLS connection, and one for the Internet connection. Such an identifier of a circuit may be referred to as a transport locator (TLOC). In some embodiments, the circuit preference may be organized using TLOCs as an identifier of the circuit that is in the circuit preference. The TLOCs may be unique in the internal network domain 105.

In some embodiments, the edge network devices 110 may communicate using typical communication protocols, such as Open Shortest Path First (OSPF), Border Gateway Protocol (BGP), Virtual Router Redundancy Protocol (VRRP), and Bi-directional Forwarding Detection (BFD), among others. Additionally or alternatively, the edge network devices 110 may support other network functionalities such as Virtual Local Area Network (VLAN) tagging, Quality of Service (QoS) monitoring, Service Level Agreements (SLA), Internet Protocol (IP) forwarding, Internet Protocol Security (IPsec), among others.

In some embodiments, one or more of the edge network devices 110 and/or the control device 120 may be implemented as one or more virtual machines operating on one or more physical computing devices. Additionally or alternatively, the edge network devices 110 and/or the control device 120 may each include an individual stand-alone computing device.

Modifications, additions, or omissions may be made to FIG. 1 without departing from the scope of the present disclosure. For example, while illustrated as including four edge network devices 110 and one control device 120, the system 100 may include any number of edge network devices 110 and control devices 120, such as thousands or tens of thousands of edge network devices 110 and more than five control devices 120. As another example, as illustrated as a single communication network 130, the communication network 130 may include multiple types of communication connections.

FIG. 2 illustrates another example system 200 of network components implementing a software-defined network, in accordance with one or more embodiments of the present disclosure. The example system 200 may include multiple edge network devices 210 (such as a first edge network device 210a, a second edge network device 210b, and a third edge network device 210c) that may be similar or comparable to the edge network devices 110 of FIG. 1. The edge network devices 210 may communicate within an internal network domain 205 (that may be similar or comparable to the internal network domain 105 of FIG. 1). The example system 200 may also include multiple communication networks (such as a first communication network 260 and a second communication network 270). The system 200 may include a local computing device 250a in communication with the first edge network device 210a and a remote computing device 250b in communication with the second and third edge network devices 210b and 210c.

The edge network devices 210a, 210b, and 210c may include first circuits 220a/220b/220c (respectively) configured to communicate over the modality of the first communication network 260 and second circuit 222a/222b/222c (respectively) configured to communicate over the modality of the second communication network 270. In some embodiments, the first communication network 260 may be in communication with the second communication network 270 such that a tunnel from one edge network device 210 to another may traverse both the first communication network 260 and the second communication network 270.

The circuits 220/222 may be configured to communicate over a given modality, such as an MPLS circuit configured to communicate over an MPLS network, a broadband circuit configured to communicate over a broadband Internet connection, an LTE circuit configured to communicate over an LTE cellular network, an LTE Advanced circuit configured to communicate over an over an LTE Advanced cellular network, a WiMAX circuit configured to communicate over a WiMAX network, an HSPA+ circuit configured to communicate over an HSPA+ network, or any other suitable circuit configured for transmission of data over any modality of communication. In some embodiments, the communication networks 260 and 270 may be one or more of an MPLS communication network, broadband communication network, Internet communication network, cellular network (e.g., LTE or LTE Advanced), WiMAX communication network, an HSPA+ communication network, or any other suitable communication network configured for transmission of data.

In some embodiments, the edge network devices 210 may encapsulate the data to be transmitted. For example, the data may be encapsulated using a generic routing encapsulation (GRE) algorithm, an IPsec algorithm, or any other suitable encapsulation algorithm. In some embodiments, the edge network devices 210 may not use encapsulation.

In some embodiments, the local computing device 250a may send a data flow to the edge network device 210a destined for the remote computing device 250b. The first edge network device 210a may send data to reach the remote computing device 250b via either the second edge network device 210b or the third edge network device 210c. Additionally, because each of the edge network devices 210 has two circuits, and the two communication networks are in communication, as illustrated in FIG. 2, there are eight potential tunnels between the first edge network device 210a and the second or third edge network devices 210b, 210c. For example, over the first circuit 220a (e.g., initially traversing the first communication network 260), there are tunnels 281, 282, 283, and 284 and over the second circuit 222a (e.g., initially traversing the second communication network 270), there are tunnels 285, 286, 287, and 288. The tunnels 282, 284, 285, and 287 transition between communication networks during the route from the first edge network device 210a to the second or third edge network devices 210b, 210c. Thus, the first edge network device 210a may send the data flow from the local computing device 250a along any of the tunnels 281-288 and the second or third edge network device 210b/210c may route the data flow to the remote computing device 250b.

In some embodiments, each of the tunnels 281-288 may be conceptually point-to-point tunnels within the internal network domain 205. For example, the first edge network device 210a may conceptualize the second and third edge network devices 210b and/or 210c as next hops. In these and other embodiments, such an arrangement alleviates certain considerations in determining back-up or redundant network channels because the risks of loops or other anomalies are not pertinent.

In some embodiments, the first edge network device 210a may provision more than one of the tunnels 281-288 such that a primary tunnel is prepared to carry the data flow and one or more secondary tunnels are also prepared to carry network traffic. In these and other embodiments, the selection of which tunnel is the primary tunnel and which tunnel is the secondary tunnel may be based on circuit preferences of the first edge network device 210a and/or the circuit preferences of the second and/or third edge network devices 210b and 210c. In some embodiments, the first edge network device 210a may provision fewer than all eight tunnels 281-288. For example, the first edge network device 210a may provision the four highest preference tunnels, or the tunnels with a preference above a threshold.

In some embodiments, the circuit preference may include a ranking score for each circuit 220/222 and a TLOC that identifies the circuit 220/222. For example, each circuit 220/222 may be given a ranking score between 0-100, where a ranking score of 0 may indicate a low preference for the corresponding circuit 220/222 and a ranking score of 100 may indicate a high preference for the corresponding circuit 220/222.

Examples of circuit preference may be illustrated in the following tables:

Edge Network Device 210a

| TLOC | Rank |
|---|---|
| 125378 (identifying the first circuit 220a) | 75 |
| 698733 (identifying the second circuit 222a) | 0 |

Edge Network Device 210b

| TLOC | Rank |
|---|---|
| 145928 (identifying the first circuit 220b) | 100 |
| 183025 (identifying the second circuit 222b) | 50 |

Edge Network Device 210c

| TLOC | Rank |
|---|---|
| 987523 (identifying the first circuit 220c) | 100 |
| 234834 (identifying the second circuit 222c) | 50 |

The ranking scores may be based on the type of circuit, the type of encapsulation algorithm used, the modality of communication network over which the corresponding circuit may transmit and/or receive data, other factors, or any combination thereof. For example, the edge network devices 210 may generate a lower ranking score for a circuit configured to communicate over an LTE communication network as compared to a circuit configured to communicate over an MPLS communication network. As another example, the edge network devices 210 may generate a higher ranking score for a circuit configured to communicate over a broadband Internet communication network as compared to a circuit configured to communicate over an LTE communication network using any encapsulation algorithm because the LTE communication network may charge to transmit and/or receive data.

In some embodiments, the ranking scores may be selected by the edge network devices 210 based on any of a variety of additional factors. For example, the ranking scores may be based on the viability of a circuit (e.g., a damaged circuits or circuits coupled to a physically damaged communication networks may have a low score). As another example, the ranking scores may be based on transmission rates, or other network performance metrics (e.g., QoS metrics). For example, a higher ranking score may be generated for a circuit that has a higher data rate for transmitting and/or receiving data. As another example, the ranking scores may be based on costs. For example, a higher ranking score may be generated for a circuit that does not incur additional costs for transmitting and/or receiving data. As another example, the ranking scores may be based on processing overhead of the data. For example, a higher ranking score may be generated for a circuit that does not encrypt the data during circumstances in which there is a large amount of data to distribute or for an edge network device 210 that does not receive sensitive data, since encryption may use more time to prepare the data to be transmitted. In these and other embodiments, the ranking scores may be determined to improve efficiency of transmitting and/or receiving data within the system 200. Additionally, the ranking scores may be based on any number or combination of the factors described above.

In some embodiments, the circuit preference may vary over time, or by the time of day. For example, for a given modality of communication (e.g., broadband business Internet), the modality may be heavily used with lower bandwidth during certain hours of the day and other times, that modality may have a higher bandwidth and the changes in bandwidth may be reflected in circuit preference, for example, via the ranking scores. For example, higher preference may be given to such a modality during off-peak hours.

In some embodiments, the edge network devices 210 may determine an aggregate ranking score for each tunnel between the edge network devices 210 by combining the ranking score of the individual circuits of the edge network devices 210 in the different tunnels. For example, to determine an aggregate ranking score for the tunnel 281, the first edge network device 210a may determine an aggregate ranking score for the first circuit 220a of the first edge network device 210a and/or for the first circuit 220b of the second edge network device 210b. While described below as simple addition, it will be appreciated that any mathematical or other combination may be used to combine the two scores, for example, by weighting one score more than another, etc. For example, a given edge network device (e.g., the edge network device 220b) may be given a weighting score such that the preference of that edge network device weighs more heavily than that of other edge network devices (e.g., the preference of the edge network device 220b may weigh more heavily than the preference of the edge network device 220c).

Following the examples above, for the tunnel 281, the first circuit 220a may have a ranking score of 75, the first circuit 220b may have a ranking score of 100 such that the aggregate ranking score for the tunnel 281 may be one hundred seventy-five (e.g., 75+100=175). As another example, for the tunnel 283, the first circuit 220a may have a ranking score of 75, the second circuit 222b may have a ranking score of 50 such that the aggregate ranking score for the tunnel 283 may be may be one hundred twenty-five (e.g., 75+50=125).

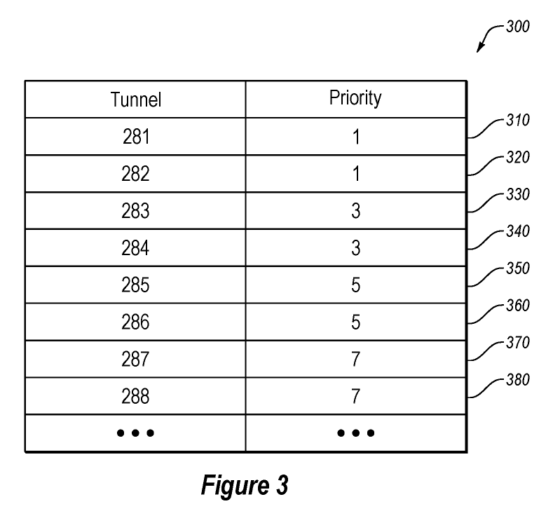

In some embodiments, based on the circuit preferences of the edge network devices 210, the edge network device 210a may designate a priority of the one or more potential tunnels. For example, the edge network device 210a may designate the highest aggregate ranking score tunnels as the highest priority tunnels. In some embodiments, such an analysis may be performed in response to receiving a data flow. Additionally or alternatively, such an analysis may be performed before receiving a data flow such that after receiving a data flow, the edge network device 210a may look up in a table or database to see which tunnel has the highest preference and route the data flow along that tunnel. An example of such a table is illustrated in FIG. 3.

In some embodiments, two or more tunnels between the edge network devices 210 may include equal or similar preferences. In these and other embodiments, the edge network device 210a may determine that the two or more tunnels with equal or similar preferences are all primary tunnels and may transmit data to the other edge network devices 210b and 210c over the two or more primary tunnels instead of over a single primary tunnel. For example, the first edge network device 210a may utilize equal cost multi-path routing (ECMP) through the two or more tunnels.

In some embodiments, the edge network devices 210b and/or 210c may transmit circuit preferences to a control device (not illustrated). In these and other embodiments, the edge network device 210a may obtain the circuit preferences from the control device or from the other edge network devices 210b and/or 210c. In some embodiments, a given circuit preference may identify the corresponding edge network device (e.g., 210b and/or 210c) that generated the given circuit preference.

In some embodiments, the edge network device 210a may determine whether a tunnel has had an interruption in data flow. For example, the edge network device 210a may monitor one or more aspects of network performance, such as QoS metrics, of the tunnels. As another example, the edge network device 210a may regularly send monitoring packets (e.g., keep-alive packets) along the provisioned tunnels and if a given number of packets fail to return, the edge network device 210a may determine that the tunnel has had an interruption in data flow. If the edge network device 210a determines a tunnel has had an interruption in data flow (e.g., one or more of the QoS metrics is outside of a threshold range, or keep-alive packets are not being returned), the edge network device 210a may automatically route data along a provisioned secondary tunnel. For example, the edge network device 210a may adjust the priority of the primary tunnel based on the interruption in data flow, and select the tunnel with the highest priority after the adjustment. In these and other embodiments, such a transition from one tunnel to another may occur rapidly. For example, the transition may occur such that no packets are dropped, or a number of packets below a threshold number are dropped.

Modifications, additions, or omissions may be made to FIG. 2 without departing from the scope of the present disclosure. For example, while illustrated as including a certain number of edge network devices 210, the system 200 may include any number of edge network devices 210. As another example, while illustrated as including two communication networks 260 and 270, any number of communication networks may be utilized. Likewise, while illustrated as each edge network device 210 including two circuits 220 and 222, any number of circuits for any number of modalities may be utilized.

FIG. 3 illustrates an example table 300 of tunnel priorities, in accordance with one or more embodiments of the present disclosure. The table of FIG. 3 is based on the routes 281-288 of FIG. 2 and the example preferences used in the tables in the description of FIG. 2. The table 300 includes a column of identifiers to identify a tunnel, and a column to provide a priority for the given tunnel. The table 300 has rows 310-380. The table 300 may be stored as a database, as a lookup table, or any other format.

The row 310 corresponds to the tunnel 281, with a priority of 1. As illustrated in FIG. 2 and the tables above, the tunnel 281 utilizes the first circuit 220a of the first edge network device 210a (with a ranking of 75) and the first circuit 220b of the second edge network device 210b (with a ranking of 100). Because the aggregate ranking score is 175, the tunnel 281 has a priority score of 1.

The row 320 corresponds to the tunnel 282, with a priority of 1. As illustrated in FIG. 2 and the tables above, the tunnel 282 utilizes the first circuit 220a of the first edge network device 210a (with a ranking of 75) and the first circuit 220c of the third edge network device 210c (with a ranking of 100). Because the aggregate ranking score is 175, the tunnel 282 has a priority score of 1.

The row 330 corresponds to the tunnel 283, with a priority of 3. As illustrated in FIG. 2 and the tables above, the tunnel 283 utilizes the first circuit 220a of the first edge network device 210a (with a ranking of 75) and the second circuit 222b of the second edge network device 210b (with a ranking of 50). The tunnel 283 may transition between the first communication network 260 and the second communication network 270 en route from the first edge network device 210a to the second edge network device 210b. Because the aggregate ranking score is 125, the tunnel 283 has a priority score of 3.

The row 340 corresponds to the tunnel 284, with a priority of 3. As illustrated in FIG. 2 and the tables above, the tunnel 284 utilizes the first circuit 220a of the first edge network device 210a (with a ranking of 75) and the second circuit 222c of the third edge network device 210c (with a ranking of 50). The tunnel 284 may transition between the first communication network 260 and the second communication network 270 en route from the first edge network device 210a to the third edge network device 210c. Because the aggregate ranking score is 125, the tunnel 284 has a priority score of 3.

The row 350 corresponds to the tunnel 285, with a priority of 5. As illustrated in FIG. 2 and the tables above, the tunnel 285 utilizes the second circuit 222a of the first edge network device 210a (with a ranking of 0) and the first circuit 220b of the second edge network device 210b (with a ranking of 100). The tunnel 285 may transition between the second communication network 270 and the first communication network 260 en route from the first edge network device 210a to the second edge network device 210b. Because the aggregate ranking score is 100, the tunnel 285 has a priority score of 5.

The row 360 corresponds to the tunnel 286, with a priority of 5. As illustrated in FIG. 2 and the tables above, the tunnel 286 utilizes the second circuit 222a of the first edge network device 210a (with a ranking of 0) and the first circuit 220c of the third edge network device 210c (with a ranking of 100). The tunnel 286 may transition between the second communication network 270 and the first communication network 260 en route from the first edge network device 210a to the third edge network device 210c. Because the aggregate ranking score is 100, the tunnel 286 has a priority score of 5.

The row 370 corresponds to the tunnel 287, with a priority of 7. As illustrated in FIG. 2 and the tables above, the tunnel 287 utilizes the second circuit 222a of the first edge network device 210a (with a ranking of 0) and the second circuit 222b of the second edge network device 210b (with a ranking of 50). Because the aggregate ranking score is 50, the tunnel 287 has a priority score of 7.

The row 380 corresponds to the tunnel 288, with a priority of 7. As illustrated in FIG. 2 and the tables above, the tunnel 288 utilizes the second circuit 222a of the first edge network device 210a (with a ranking of 0) and the second circuit 222c of the third edge network device 210c (with a ranking of 50). Because the aggregate ranking score is 50, the tunnel 288 has a priority score of 7.

In some embodiments, the table 300 may be utilized by an edge network device (such as the edge network device 210a of FIG. 2) in determining through which tunnel to route a data flow. For example, the table 300 may be populated upon the initialization of an edge network device, may be populated based on a received data flow, or at any other time. In these and other embodiments, the table 300 may be updated at regular intervals, or when a control device identifies a change in an edge network device or a communication network.

In some embodiments, an edge network device may modify the priorities of the table 300 based on a detected interruption in data flow through a given tunnel. For example, if an edge network device detects an interruption in data flow along the tunnel 281, the edge network device may adjust the priority of the tunnel 281 to a priority of 8. After adjusting the priority, the edge network device may send data flows along the tunnel 282, instead of along both the tunnels 281 and 282.

Modifications, additions, or omissions may be made to FIG. 3 without departing from the scope of the present disclosure. For example, the table 300 may include any other number of fields that may be related to the priority. For example, if the priority changes with the time of day, the table 300 may include multiple columns for priority for different segments of time. As another example, the table 300 may include one or more fields that include the TLOCs at either or both ends of a respective tunnel. As another example, the table 300 may include one or more fields identifying preference information for one or more of the circuits associated with a given tunnel.

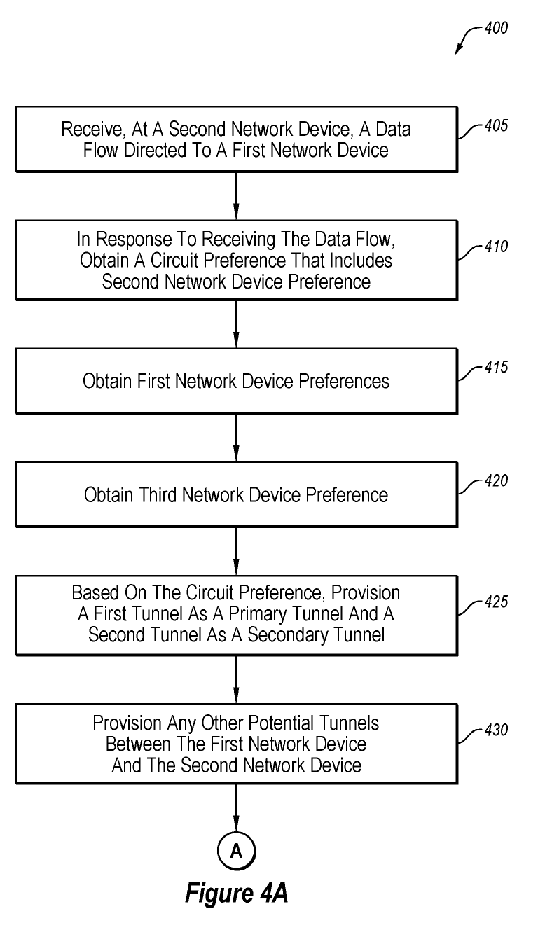

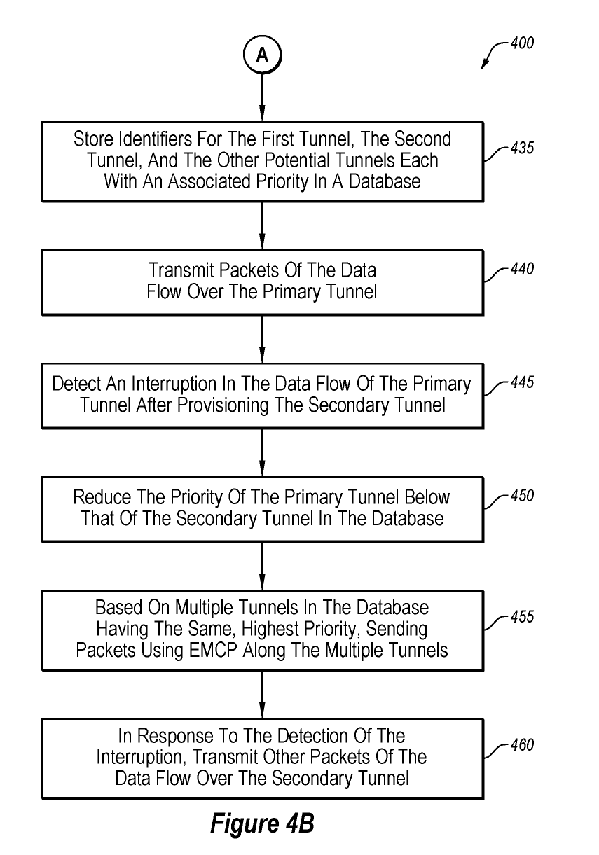

FIGS. 4A and 4B illustrate a flowchart of an example method 400 of network route provisioning, in accordance with one or more embodiments of the present disclosure. Although illustrated as discrete blocks, various blocks may be divided into additional blocks, combined into fewer blocks, or eliminated, depending on the particular implementation.

At block 405, a data flow directed to a first network device may be received at a second network device. For example, a local computing device (e.g., the local computing device 250a of FIG. 2) may send a data flow that is received by the second network device (e.g., the edge network device 210a of FIG. 2) to be routed to a first network device (e.g., the edge network device 210b of FIG. 2) on its way to a remote computing device (e.g., the remote computing device 250b of FIG. 2).

At block 410, in response to receiving the data flow, a circuit preference may be obtained that includes the second network device preference. For example, the second network device may look up the preference information in a table or other storage location of the second network device. As another example, the second network device may obtain the second network device preference from a control device (e.g., the control device 120 of FIG. 1).

At block 415, network device preferences of the first network device may be obtained. For example, the control device may send the first network device preferences to the second network device, or the first network device may provide its preferences directly to the second network device.

At block 420, third network device preferences may be obtained. For example, the third network device (e.g., the edge network device 210c of FIG. 2) may include an alternative route for the ultimate destination of the data flow received at the second network device. The second network device may obtain the third network device preferences from the control device or from the third network device directly.

At block 425, based on the circuit preference (which may include the first, second, and/or third network device preferences), a first tunnel may be provisioned as a primary tunnel and a second tunnel may be provisioned as a secondary tunnel. For example, in embodiments in which the circuit preference includes the preferences of the first, second, and third network devices, the primary tunnel may represent the tunnel with the highest aggregate ranking score of the preferences. For example, with reference to FIGS. 2 and 3, tunnel 281 may be provisioned as at least one of the primary tunnels and the tunnel 287 may be provisioned as at least one of the secondary tunnels.

At block 430, any other potential tunnels between the first network device and the second network device may be provisioned. Additionally or alternatively, other potential tunnels between the first network device and the third network device may be provisioned. For example, at the completion of the block 430, all of the tunnels 281-288 of FIG. 2 may be provisioned.

With reference to FIG. 4B, at block 435, identifiers for the first tunnel, the second tunnel, and the other potential tunnels may each be stored with an associated priority in a database. For example, the database may be similar or comparable to the table of FIG. 3.

At block 440, packets of the data flow may be transmitted over the primary tunnel. For example, the packets of the data flow may be sent along the tunnel of the most preferred circuits.

At block 445, an interruption in the data flow of the primary tunnel may be detected. For example, the second network device may no longer have keep-alive packets returned, or a QoS metric may drop below a threshold level for the primary tunnel. In these and other embodiments, the interruption in the data flow may be detected after the second tunnel has been provisioned.

At block 450, the priority of the primary tunnel may be reduced below that of the second tunnel in the database. For example, with reference to FIG. 3, the priority of the tunnel 281 may be reduced from 1 to 8.

At block 455, based on multiple tunnels in the database having the same, highest priority, the data packets may be sent along the multiple tunnels using ECMP. For example, with reference to the table of FIG. 3, if the tunnels 281 and 282 had priorities lowered below 3, the tunnels 234 and 284 may be utilized to carry packets of the data flow.

At block 460, in response to the detection of the interruption, other packets of the data flow may be transmitted over the secondary tunnel. For example, any additional packets of the data flow received by the second network device may be automatically sent along the secondary tunnel. In these and other embodiments, because the secondary tunnel was provisioned before detecting interruption in data flow, no packets or a small number of packets (e.g., less than fifty) may be lost.

One skilled in the art will appreciate that, for these processes, operations, and methods, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. For example, the block 415 may be omitted in some embodiments, e.g., in which the circuit preference does not include the first network device preferences. As another example, the block 420 may be omitted in embodiments in which the third network device is not included or does not represent an alternative path to the ultimate destination of the data flow. As an additional example, the block 450 may be omitted and any other mechanism may be utilized to transition from the primary tunnel to the secondary tunnel. As another example, the block 455 may be omitted in embodiments in which a single tunnel has the highest priority, or is otherwise selected/designated as the secondary tunnel.

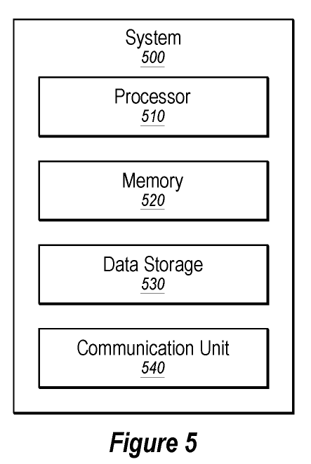

FIG. 5 illustrates an example computing system 500, according to at least one embodiment described in the present disclosure. The computing system 500 may include any suitable system, apparatus, or device configured to provision network routes. The computing system 500 may include a processor 510, a memory 520, a data storage 530, and a communication unit 540, which all may be communicatively coupled. In some embodiments, any of the network devices (e.g., the edge network devices 110 or 210 of FIGS. 1 and 2), control devices (e.g., the control devices 120 of FIG. 1), or other computing devices of the present disclosure may be implemented as the computing system 500. Additionally or alternatively, one or more of the network devices, control devices, or other computing devices may be implemented as virtualized machines operating on a physical computing system such as the computing system 500.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of network or physical locations that are configured to perform individually or collectively any number of operations described in the present disclosure. In some embodiments, the processor 510 may interpret and/or execute program instructions and/or process data stored in the memory 520, the data storage 530, or the memory 520 and the data storage 530. In some embodiments, the processor 510 may fetch program instructions from the data storage 530 and load the program instructions into the memory 520.

After the program instructions are loaded into the memory 520, the processor 510 may execute the program instructions, such as instructions to perform the method 400 of FIGS. 4A-4B. For example, the processor 510 may obtain a circuit preference for a network device and provision a primary tunnel and a secondary tunnel based on the preferences. As another example, the processor 510 may detect an interruption in the data flow of the primary tunnel and may shift over to the secondary tunnel for transmitting network traffic.

The memory 520 and the data storage 530 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 510. In some embodiments, the computing system 500 may or may not include either of the memory 520 and the data storage 530.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

The communication unit 540 may include any component, device, system, or combination thereof that is configured to transmit or receive information over a network, such as an MPLS connection, the Internet, a cellular network (e.g., an LTE network), etc. In some embodiments, the communication unit 540 may communicate with other devices at other locations, the same location, or even other components within the same system. For example, the communication unit 540 may include a modem, a network card (wireless or wired), an optical communication device, an infrared communication device, a wireless communication device (such as an antenna), a chipset (such as a Bluetooth device, an 802.6 device (e.g., Metropolitan Area Network (MAN)), a WiFi device, a WiMax device, cellular communication facilities, or others), and/or the like, or any combinations thereof The communication unit 540 may permit data to be exchanged with a network and/or any other devices or systems described in the present disclosure. For example, the communication unit 540 may allow the computing system 500 to communicate with other systems, such as network devices, control devices, and/or other networks.

Modifications, additions, or omissions may be made to the computing system 500 without departing from the scope of the present disclosure. For example, the data storage 530 may be multiple different storage mediums located in multiple locations and accessed by the processor 510 through a network.

As indicated above, the embodiments described in the present disclosure may include the use of a special purpose or general purpose computer (e.g., the processor 510 of FIG. 5) including various computer hardware or software modules, as discussed in greater detail below. Further, as indicated above, embodiments described in the present disclosure may be implemented using computer-readable media (e.g., the memory 520 or data storage 530 of FIG. 5) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, or some other hardware) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system comprising:
a first network device with a first circuit configured to communicate over a first modality and a second circuit configured to communicate over a second modality;
a second network device with a third circuit configured to communicate over the first modality and a fourth circuit configured to communicate over the second modality, the second network device configured to perform operations comprising:
receive a data flow directed to the first network device;
in response to receiving the data flow, obtain a circuit preference including second network device circuit preference of the second network device between the third circuit and the fourth circuit;
based on the circuit preference, provision a first tunnel from the third circuit over the first modality to the first network device as a primary tunnel;
based on the circuit preference, provision a second tunnel from the fourth circuit over the second modality to the first network device as a secondary tunnel;
transmit a first packet in the data flow over the primary tunnel;
detect an interruption in the data flow of the primary tunnel after provisioning the second tunnel; and
in response to the detection of the interruption, transmit a second packet in the data flow over the secondary tunnel.

2. The system of claim 1, wherein the circuit preference also includes preferences of the first network device between the first circuit and the second circuit.

3. The system of claim 1, wherein detecting the interruption in data flow of the primary tunnel includes detecting a degradation in network performance of the primary tunnel below a threshold.

4. The system of claim 1, wherein the circuit preference is based on network performance of the third circuit and the fourth circuit.

5. The system of claim 1, wherein the operations further comprise:
provision any other potential tunnels between the first network device and the second network device; and
store identifiers for the first tunnel, the second tunnel, and the other potential tunnels each with an associated priority in a database.

6. The system of claim 5, wherein the operations further comprise:
reduce the priority of the primary tunnel below the priority of the second tunnel in the database; and
based on multiple tunnels in the database having the same priority as a highest priority in the database, send packets of the data flow using equal cost multi-path (ECMP) routing along the multiple tunnels.

7. The system of claim 1, further comprising a third network device at the same location as the first network device, the third network device including a fifth circuit and a sixth circuit, and wherein the circuit preference includes preferences of the third network device between the fifth circuit and the sixth circuit.

8. The system of claim 1, wherein the first modality and the second modality are each selected from a list that includes a broadband Internet connection, a multi-protocol label switching (MPLS) connection, and a cellular Internet connection.

9. The system of claim 1, wherein at least one of the tunnels traverses both the first modality and the second modality.

10. A method of network route provisioning, the method comprising:
receiving, at a second network device, a data flow directed to a first network device, the first network device including a first circuit to communicate over a first modality and a second circuit to communicate over a second modality, and the second network device including a third circuit to communicate over the first modality and a fourth circuit to communicate over the second modality;
in response to receiving the data flow, obtaining a circuit preference including second network device circuit preference between the third circuit and the fourth circuit;
based on the circuit preference, provisioning a first tunnel from the third circuit over the first modality to the first network device as a primary tunnel;
based on the circuit preference, provisioning a second tunnel from the fourth circuit over the second modality to the first network device as a secondary tunnel;
transmitting a first packet in the data flow over the primary tunnel;
detecting an interruption in the data flow of the primary tunnel after provisioning the second tunnel; and
in response to the detection of the interruption, transmitting a second packet in the data flow over the secondary tunnel.

11. The method of claim 10, further comprising obtaining first network device preferences of the first network device between the first circuit and the second circuit, and wherein the circuit preference also includes the first network device preferences.

12. The method of claim 10, wherein detecting the interruption in data flow of the primary tunnel includes detecting a degradation in network performance of the primary tunnel below a threshold.

13. The method of claim 10, wherein the circuit preference is based on network performance of the third circuit and the fourth circuit.

14. The method of claim 10, further comprising:
provisioning any other potential tunnels between the first network device and the second network device; and
storing identifiers for the first tunnel, the second tunnel, and the other potential tunnels each with an associated priority in a database.

15. The method of claim 14, further comprising:
reducing the priority of the primary tunnel below the priority of the second tunnel in the database; and
based on multiple tunnels in the database having the same priority as a highest priority in the database, sending packets of the data flow using equal cost multi-path (ECMP) routing along the multiple tunnels.

16. The method of claim 10, further comprising obtaining third network device preferences from a third network device at the same location as the first network device between a fifth circuit and a sixth circuit of the third network device, and wherein the circuit preference includes the third network device preferences.

17. The method of claim 10, wherein the first modality and the second modality are each selected from a list that includes a broadband Internet connection, a multi-protocol label switching (MPLS) connection, and a cellular Internet connection.

18. The method of claim 10, wherein obtaining the circuit preference includes priorities of one or more of the third circuit and the fourth circuit from a controller.

19. A non-transitory computer readable medium containing instructions that, when executed by one or more processors, are configured to cause a device to perform one or more operations, the operations comprising:
receive, at a second network device, a data flow directed to a first network device, the first network device including a first circuit to communicate over a first modality and a second circuit to communicate over a second modality, and the second network device including a third circuit to communicate over the first modality and a fourth circuit to communicate over the second modality;
in response to receiving the data flow, obtain a circuit preference of the second network device between the third circuit and the fourth circuit;
based on the circuit preference, provision a first tunnel from the third circuit over the first modality to the first network device as a primary tunnel;
based on the circuit preference, provision a second tunnel from the fourth circuit over the second modality to the first network device as a secondary tunnel;
transmitting a first packet in the data flow over the primary tunnel;
detecting an interruption in the data flow of the primary tunnel after provisioning the second tunnel; and
in response to the detection of the interruption, transmit a second packet in the data flow over the secondary tunnel.

20. The computer readable medium of claim 19, the operations further comprising obtain first network device preferences of the first network device between the first circuit and the second circuit, and wherein the circuit preference also includes the first network device preferences.
